(19) United States
(12) Patent Application Publication
(10) Pub. No.: US 2024/0109198 A1
(43) Pub. Date: Apr. 4, 2024

(54) METHOD FOR HANDLING OBJECTS, AND HANDLING SYSTEM

(71) Applicant: J. SCHMALZ GMBH, Glatten (DE)

(72) Inventors: Matthias FREY, Sulz-Dürrenmettstetten (DE); Jeremia SIPPLE, Glatten (DE)

(21) Appl. No.: 18/373,464

(22) Filed: Sep. 27, 2023

(30) Foreign Application Priority Data
Oct. 4, 2022 (DE) 10 2022 125 564.6

(51) Int. Cl. B25J 9/16; B25J 9/04

(52) U.S. Cl. CPC B25J 9/1687; B25J 9/043; B25J 9/1682; B25J 9/1697

(57) ABSTRACT

The invention relates to a method for handling objects (54) by means of a handling system (10) comprising a robot (12) with a first robot arm (20-1) and a second robot arm (20-2), a source container (52), a target container (56), and an identification device (58) for characterizing the source container and the target container, wherein the robot arms are pivoted about the main axis in such a way that each robot arm alternately approaches the source container and the target container, wherein the robot arms, during their movement between the source container and the target container, pass through a zero position in which the robot arms are located neither above the source container nor above the target container, wherein, when the robot arms are in the zero position, the source container and/or the target container is characterized, in particular visually detected, by means of the identification device. The invention also relates to a handling system designed for this purpose.

The invention relates to a method for handling objects and a handling system designed therefor.

Handling systems are used, for example, when picking goods in warehouses, where they are used in particular to grip goods from a storage container having a plurality of goods (so-called “bin-picking”) and to move them to another location, e.g., into a transport container. Such handling systems usually comprise a robot with a robot arm on which an end effector for gripping an object is arranged.

For efficient use, it is of crucial importance in this context how many objects per time interval can be gripped and moved to another location by means of the handling system, which is usually characterized as a “pick performance” or “gripping performance” of the handling system.

The invention concerns the task of being able to handle objects with high gripping performance, in particular to be able to move them between two locations.

This task is achieved by a method having the features of Claim 1. The method is a method for handling objects, e.g., for picking objects.

The method is carried out by means of a handling system. In this respect, the method is in particular also a method for operating a handling system.

The handling system comprises a robot with a first robot arm and a second robot arm. It is also conceivable for the robot to have more than two robot arms. An end effector for in each case gripping an object is arranged on each of the robot arms. In this respect, the robot is in particular designed to grip several objects, in particular simultaneously. In particular, the robot is designed to displace the end effectors and, optionally, objects gripped therewith, in particular along mutually independent movement paths. The end effector may, for example, be a pneumatically actuatable gripper, in particular a suction gripper.

The robot arms are pivotable about a common, in particular vertical, main axis. For example, it is conceivable that the robot arms are mounted on a common robot base so as to pivot about the main axis. It is also conceivable that each robot arm is part of a separate robot unit. The robot units are then arranged in particular in such a way that the robot arms are pivotable about a common axis (main axis).

The robot arms each have Scara kinematics, in particular 4-axis Scara kinematics. In particular, the robot arms each have a spindle. In particular, the respective end effector is arranged on the spindle, preferably on one end of the spindle. The spindle is preferably part of a spindle drive. The spindle is preferably designed to drive a translational and/or rotational actuating movement of the end effector, in particular with respect to a spindle axis preferably parallel to the main axis, in particular a vertical spindle axis.

The handling system also comprises at least one source container for receiving objects. In particular, several objects can be provided in the source container, in particular be received therein. In this respect, the handling system can comprise a source container with a plurality of objects arranged therein.

The handling system also comprises at least one target container for receiving objects. It is conceivable that the target container is empty at the beginning of a handling process. It is also conceivable that the target container is already partially filled, for example with objects, at the beginning of a handling process. In particular, the source container can be a storage container and the target container can be a transport container, e.g., a parcel box.

The at least one source container and the at least one target container are arranged distributed around the main axis, in particular along a circumference, in such a way that the robot arms, in particular independently of one another, can grip objects from the source container and can transfer them into the target container and deposit them there. The at least one source container and the at least one target container are also arranged in such a way that the robot arms are pivotable in relation to the main axis across the source container and the target container. In this respect, respective displacement planes of the robot arms about the main axis, in particular from an upper edge of the source container and an upper edge of the target container, are spaced apart along the main axis.

The at least one source container and the at least one target container are also arranged in such a way that the robot arms can assume a zero position in which the robot arms are located neither above the source container nor above the target container in a view along the main axis. In this respect, the robot arms are in particular arranged in the zero position in such a way that projections of the robot arms along the main axis onto a container plane in which the containers are arranged do not intersect the containers. In this zero position, the source container and the target container are freely accessible, in particular from above.

The handling system also comprises an identification device which is designed to characterize the source container and/or the target container and, optionally, objects arranged therein. The identification device comprises a source container detection unit, in particular arranged above the source container in relation to the main axis. The source container detection unit is designed to detect, in particular optically or visually, the source container and, optionally, objects provided or received therein. For example, the source container detection unit may comprise a camera.

The identification device also comprises a target container detection unit, in particular arranged above the target container in relation to the main axis. The target container detection unit is designed to detect, in particular optically or visually, the target container and, optionally, objects provided or received therein. For example, the target container detection unit may comprise a camera.

The source container detection unit and the target container detection unit are preferably arranged in such a way that the robot arms are pivotable between the source container and the source container detection unit and between the target container and the target container detection unit. In this respect, the robot arms, the source container, the target container, the source container detection unit and the target container detection unit can be arranged relative to one another in such a way that respective displacement planes of the robot arms about the main axis is arranged between a container plane, in which the containers are arranged, and a detection unit plane, in which the detection units are arranged.

According to the method, the robot arms are pivoted about the main axis in such a way that each robot arm alternately approaches the source container and the target container. It is conceivable, for example, for the robot arms to travel back and forth between the source container and the target container. In this respect, the robot arms can perform a change in direction in their movement about the main axis after a container has been approached. However, it is also conceivable for the robot arms to move in the same direction about the main axis, in particular to perform a circular movement about the main axis, which enables an alternating approach of the source container and the target container without a change in direction. In the present context, the term “approach” in particular means that the robot arms are moved over the source container or over the target container, in particular in such a way that objects can be gripped from the source container or objects can be deposited into the target container. Preferably, when a robot arm has approached the source container, an object is gripped from the source container by means of the end effector of this robot arm. Preferably, when a robot arm has approached the target container, in the event that an object is held on the end effector of this robot arm, this object is deposited into the target container.

A movement of the robot arms, in particular about the main axis, is synchronized in such a way that, when the first robot arm approaches the source container, the second robot arm approaches the target container, and vice versa. In this respect, the robot arms are moved in particular in such a way that the robot arms do not approach the same container together, i.e., are not arranged above the same container at the same time. In particular, the robot arms are in each case pivoted in the same direction about the main axis. In particular, the robot is controlled in such a way that an object is gripped from the source container and this object is deposited into the target container by the respective end effector.

According to the proposed method, the robot arms pass through the above-described zero position during their respective movement from the source container to the target container or from the target container to the source container. In particular, the movements of the robot arms are synchronized in such a way that, during their respective movement from the source container to the target container or from the target container to the source container, the robot arms assume a configuration in which the source container can be freely detected by the source container detection unit and the target container can be freely detected by the target container detection unit, i.e., a view from the source container detection unit to the source container and a view from the target container detection unit to the target container is not disturbed by the robot arms.

When the robot arms are in the zero position, the source container and/or the target container is characterized, in particular visually detected, according to the method by means of the identification device. In particular, the source container is detected by means of the source container detection unit and/or the target container is detected by means of the target container detection unit. For example, when the robot arms are in the zero position, an image of the source container and/or an image of the target container is captured. Preferably, objects received in the source container and/or the target container are also optionally characterized by means of the identification device.

According to the proposed method, objects can be moved from the source container into the target container efficiently and with high gripping performance, which can be of great advantage, for example, when picking goods. The robot arms having Scara kinematics (abbreviation for “Selective Compliance Assembly Robot Arm”), which enables comparatively fast and precisely repeatable movements, in particular contributes in this respect. Since the robot arms are pivoted in the same direction about the main axis, a collision of the robot arm can be avoided. Since the robot arms pass through a zero position during their transfer from the source container to the target container, or vice versa, it is possible to detect the source container and/or the target container by means of the identification device and to in this way characterize the containers and/or the content thereof, which enables simple process monitoring.

Within the scope of a particularly advantageous embodiment, the at least one source container and the at least one target container can be arranged opposite one another in relation to the main axis. In the zero position, the robot arms can then be located in a pivot position between the source container and the target container. In this respect, the zero position in such an embodiment is automatically passed through during a pivoting movement of a robot arm from the source container to the target container, or from the target container to the source container. In particular, it is conceivable for the source container and/or the target container to be characterized by means of the identification device in the course of a pivoting movement of the robot axis about the main axis. It is in particular possible to detect the source container and/or the target container without having to stop a movement of the robot arms about the main axis.

According to a particularly advantageous embodiment of the method, the robot arms are first transferred into the zero position (step a). In particular, the robot arms are pivoted about the main axis in such a way that the robot arms assume a position in which the robot arms are located neither above the source container nor above the target container in a view along the main axis.

In a further step (step b), the source container and/or the target container is characterized by means of the identification device. In particular, the source container is detected by means of the source container detection unit and/or the target container is detected by means of the target container detection unit. For example, it is conceivable that at least one image of the source container is captured, in particular by means of the source container detection unit, and/or one image of the target container is captured, in particular by means of the target container detection unit.

In a further step (step c), the robot arms are then pivoted in a first direction about the main axis (e.g., in the clockwise direction) in such a way that the first robot arm approaches the source container and the second robot arm approaches the target container. In this respect, the robot arms each approach a different container.

In a further step (step d), a gripping action or depositing action is carried out by means of the end effectors. Specifically, an object is gripped from the source container by means of the end effector of the first robot arm (i.e., the robot arm that has approached the source container). For this purpose, it is conceivable for the end effector of the first robot arm to be displaced along an axis parallel to the main axis, in particular a vertical axis, for example by the aforementioned spindle. In the event that an object is held on the end effector of the second robot arm, this object is deposited into the target container. For this purpose, it is conceivable for the end effector of the second robot arm to be displaced along an axis parallel to the main axis, in particular a vertical axis, for example by the aforementioned spindle.

Preferably, the robot arms are pivoted in step c) and/or the objects are gripped or deposited in step d) as a function of step b).

In a further step (step e), the robot arms are again transferred into the zero position, in particular by pivoting the robot arms in the first direction or in a second direction opposite to the first direction (e.g., in the counterclockwise direction) about the main axis.

In a further step (step f), the source container and/or the target container is then again characterized by means of the identification device. In particular, the source container is detected by means of the source container detection unit and/or the target container is detected by means of the target container detection unit. Preferably, at least one image of the source container is captured, in particular by means of the source container detection unit, and/or one image of the target container is captured, in particular by means of the target container detection unit.

In a further step (step g), the robot arms are then pivoted in the first direction or in a second direction opposite to the first direction (e.g., in the clockwise direction) about the main axis in such a way that the first robot arm approaches the target container and the second robot arm approaches the source container.

In a further step (step h), an object is gripped from the source container by means of the end effector of the second robot arm (i.e., the robot arm that has approached the source container). For this purpose, it is conceivable for the end effector of the second robot arm to be displaced along an axis parallel to the main axis, in particular a vertical axis, for example by the aforementioned spindle. Moreover, in the event that an object is arranged on the end effector of the first robot arm, this object is deposited into the target container. Preferably, the object gripped in step c) by means of the end effector of the first robot arm is deposited into the target container. For this purpose, it is conceivable for the end effector of the first robot arm to be displaced along an axis parallel to the main axis, in particular a vertical axis, for example by the aforementioned spindle.

Preferably, the robot arms are pivoted in step g) and/or the objects are gripped or deposited in step h) as a function of step f).

As already mentioned, by characterizing the source container and the target container, the handling process can be monitored “on the fly” in a simple manner, for example as to whether or how many objects are still or already arranged in the respective containers. However, it is particularly advantageous if the robot, in particular a pivoting movement of the robot arms about the main axis, is controlled as a function of a result of the characterization, carried out by the identification device, of the source container and/or of the target container. In particular, the robot arms can approach the source container or the target container, preferably a target position of the robot arms above the source container or above the target container, as a function of a result of the characterization of the source container or of the target container. It is particularly advantageous if the gripping of an object from the source container and/or the depositing of an object into the target container also takes place as a function of a result of the characterization of the source container or of the target container. In this respect, in the above-described embodiment of the method, the pivoting of the robot arms in step c) and/or the gripping or depositing of an object in step d) can take place as a function of step b) and the pivoting of the robot arms in step g) and/or the gripping or depositing of an object in step h) can take place as a function of step f). In this way, the handling system can be operated in a particularly efficient and undisturbed manner since incorrect grips or the depositing at unsuitable positions in the target container can be avoided.

Within the scope of an advantageous development, the identification device, in particular the source container detection unit, can be designed to ascertain object information on one or more objects received in the source container. For example, it is conceivable that the identification device, in particular the source container detection unit, is designed to ascertain, in particular identify, a geometry, in particular an outer shape, and/or position and orientation of one or more of the objects received in the source container. For this purpose, the identification device can comprise a data processing system. For example, it is conceivable that an image of the source container and of the objects arranged therein is first captured by means of the source container detection unit and object information on one or more of the objects is subsequently ascertained using image processing methods. In order to enable particularly reliable handling of the objects, characterizing the source container can in this respect comprise ascertaining, in particular identifying, object information on one or more objects arranged in the source container. Such an embodiment enables precise control of the handling system and detailed process monitoring.

According to an advantageous development, ascertaining the object information can comprise ascertaining, in particular identifying, a geometry, in particular an outer shape, and/or position and orientation of one or more of the objects arranged in the source container. In this respect, the object information can comprise information on a geometry, in particular an outer shape, and/or position and orientation of one or more objects. Moreover, it may be advantageous for a reliable and fast gripping process if ascertaining the object information comprises ascertaining a gripping point on an object to be gripped or on objects to be gripped. In this respect, the object information may also comprise information on a possible gripping point on the object(s).

As already mentioned above, it may be particularly advantageous if the robot arms are pivoted, in particular if the robot arms approach the source container, as a function of object information, ascertained by the identification device, on an object to be gripped in the source container, in particular as a function of a geometry, position and orientation and/or of a gripping point of the object.

In order to also be able to deposit an object efficiently and in a targeted manner, it may also be advantageous if the identification device, in particular the target container detection unit, is designed to ascertain, in particular identify, a position of a suitable deposit location (deposit position) in the target container. In this respect, the step of characterizing the target container by means of the identification device can comprise ascertaining or identifying a suitable deposit position in the target container, in particular for an object gripped by the robot at this time. In the aforementioned steps d) and h), the object can then advantageously be deposited in the target container at the ascertained deposit position. Ascertaining the deposit position may, in particular, comprise identifying a deposit position by means of the target container detection unit. Ascertaining the deposit position may, for example, comprise capturing an image of the target container by means of the target container detection unit and subsequently analyzing this image by means of image processing methods.

Then, advantageously, the robot arms can approach the target container and/or an object can be deposited into the target container as a function of a deposit position, ascertained by the identification device, in the target container. In particular, the robot arm that approaches the source container is pivoted as a function of a gripping point previously ascertained by the identification device on an object to be gripped in the source container, and the robot arm that approaches the target container is pivoted as a function of a previously ascertained or identified deposit position in the target container.

Ascertaining the deposit position may, for example, comprise selecting a deposit position from a plurality of deposit positions ascertained or identified by means of the identification device. The deposit position can in particular be selected as a function of one or more boundary conditions. Such a boundary condition may, for example, comprise the nature or geometry, in particular size and/or outer shape, of an object held by the robot at this time. Alternatively or additionally, a nature, geometry, in particular size and/or outer shape, and/or position and orientation of one or more of the objects already arranged in the target container at this time may also form such a boundary condition. In this way, it can be avoided, for example, that a heavy object or large object is deposited onto a small or, for example, fragile object.

Within the scope of a general aspect, the end effectors or at least a subset of the end effectors can each be connected, in particularly repeatably detachably, via a coupling device to the corresponding robot arm, in particular to the aforementioned spindle, wherein the respective end effector is pivotable about a pivot axis relative to the robot arm/spindle to which the end effector is coupled via the coupling device. The pivot axis is in particular oriented orthogonally to the main axis, preferably horizontally. Then, according to a further step of the method, before gripping an object from the source container and/or before depositing an object into the target container (cf. steps d) and h) above), the corresponding end effector can be pivoted about the pivot axis. In particular, a pivoting movement of the end effector about the pivot axis can take place as a function of previously ascertained object information on an object to be gripped, or as a function of a deposit position in the target container. In this way, even objects in different positions and orientations can be reliably gripped and deposited, which is advantageous in particular in the case of “bin-picking.” For this purpose, the handling system preferably also comprises corresponding drive devices for driving a respective pivoting movement of an end effector about the respective pivot axis.

As mentioned above, the robot arms each have Scara kinematics. Preferably, the robot arms each have three successively arranged limbs. A respective first limb can then be pivotable about the main axis. Within the scope of an advantageous development of the method, a movement of the robot arms about the main axis can then be synchronized in such a way that an (acute) angle enclosed between the first limb of the first robot arm and the first limb of the second robot arm around the main axis is not less than 120°, in particular not less than 140°, more particularly not less than 160°, more particularly not less than 170°, more particularly not less than 175°. In this way, the risk can be reduced that collisions between the robot arms or between objects held on the robot arms occur. In addition, in such an embodiment, an angular range, covered by the robot arms, about the main axis is limited so that an intermediate space between the source container and the target container can be comparatively narrow and a zero position can nevertheless be assumed.

According to a further general aspect, it may be advantageous if the identification device comprises further detection units, in particular further cameras. It can be particularly advantageous if one of these further detection units is arranged on each robot arm and is thus pivotable with the robot arm. The further detection units can in particular be arranged and designed to monitor an object held on an end effector of a robot arm. In particular, according to the method, an object held on an end effector of a robot arm, in particular its position and/or orientation, can be detected, in particular monitored, by means of the further detection unit arranged on this robot arm. It is also conceivable that the further detection units or a subset thereof are designed to identify a barcode on an object.

The task described above is also achieved by a handling system according to Claim 13. The handling system is designed to carry out one of the methods described above.

The handling system comprises a robot with a first robot arm and a second robot arm. It is also conceivable for the robot to have more than two robot arms. An end effector for in each case gripping an object is arranged on each of the robot arms. The robot arms are pivotable about a common, in particular vertical, main axis. The robot arms each have Scara kinematics, in particular 4-axis Scara kinematics. The handling system also comprises at least one source container for receiving objects. In particular, the handling system can comprise a source container with a plurality of objects arranged therein. The handling system also comprises at least one target container for receiving objects. The at least one source container and the at least one target container are arranged distributed around the main axis, in particular along a circumference, in such a way that the robot arms, in particular independently of one another, can grip objects from the source container and can transfer them into the target container and deposit them there. The at least one source container and the at least one target container are also arranged in such a way that the robot arms are pivotable in relation to the main axis across the source container and the target container. Moreover, the at least one source container and the at least one target container are arranged in such a way that the robot arms can assume a zero position in which the robot arms are located neither above the source container nor above the target container in a view from above along the main axis.

The handling system also comprises an identification device. The identification device comprises a source container detection unit, which is in particular arranged above the source container in relation to the main axis and which is designed to detect, in particular optically or visually, the source container and, optionally, objects provided or received therein. For example, the source container detection unit may comprise a camera. The identification device also comprises a target container detection unit, which is in particular arranged above the target container in relation to the main axis and which is designed to detect, in particular optically or visually, the target container and, optionally, objects provided or received therein. For example, the target container detection unit may comprise a camera.

The handling system also comprises a control device for controlling the handling system, in particular for controlling the robot and/or the identification device. The control device is configured to carry out one of the methods described above.

The advantages and optional features of the handling system described above in connection with the method can also serve to design the handling system according to Claim 13, so that reference is made to the above disclosure in this respect in order to avoid repetition.

Within the scope of an advantageous embodiment, the source container and the target container are arranged opposite one another in relation to the main axis.

It is conceivable that each robot arm is part of a separate robot unit. For example, it is possible for the robot to comprise a first Scara robot unit, which provides the first robot arm, and for the robot to comprise a second Scara robot unit, which is in particular separate, in particular spatially separate, from the first Scara robot unit and provides the second robot arm. The first Scara robot unit and the second Scara robot unit are then preferably arranged in such a way that the pivot axes of the robot arms run coaxially so that the robot arms are pivotable about a common main axis.

It is also conceivable for the first and the second robot arm to be mounted on a common robot base. For example, it is conceivable that the robot has a robot base, wherein the first robot arm and the second robot arm are fastened to the robot base so as to pivot about the main axis. In particular, the first robot arm and the second robot arm can be mounted on the robot base via a common bearing.

As already mentioned above, it may be advantageous if the robot arms each have a spindle. The spindle can in particular be designed to drive a translational and/or a rotational actuating movement with respect to a spindle axis parallel to the main axis, in particular a vertical spindle axis. For example, the spindle can be designed as a ball roller spindle. In particular, the respective end effector is arranged on the spindle, in particular on one end of the spindle. Such a spindle drive enables fast and precisely repeatable movements, which has a positive effect on a gripping performance.

Within the scope of an advantageous embodiment, the robot arms can each have three successively arranged limbs. In particular, a respective first limb of a robot arm can be pivotable, in particular rotatable, about a first axis corresponding to the main axis. In one embodiment with two robot units, the first limb can in each case be connected to the respective robot base so as to pivot about the first axis. The robot units can then in particular be arranged in such a way that the first axes run coaxially and thus form a common main axis. A respective second limb can be connected to the first limb of the corresponding robot arm so as to pivot, in particular rotate, about a respective second axis. A respective third limb can then be provided by the aforementioned spindle. In this respect, the spindle of a respective robot arm can form the third limb of this robot arm. Preferably, the spindle of a robot arm can be connected to the second limb of this robot arm so as to rotate about a respective spindle axis (third axis). The spindle can in particular be mounted rotatably about the spindle axis in such a way that it can perform both a pure rotational movement about the spindle axis and a translational movement along the spindle axis, in particular independently of one another. In particular, the spindle of a respective robot arm can extend with a main longitudinal axis along the respective spindle axis.

The robot preferably comprises corresponding drives in order to drive a pivoting movement of the limbs about the respective axes. A drive device and/or transmission device of the spindle can be arranged in the respective second limb of the robot arm.

The first axis, the second axis and the spindle axis of a robot arm, in particular of all robot arms, can advantageously run parallel to one another, in particular vertically. Such an embodiment promotes parallel movement of the individual robot arms. In this respect, the first and second limbs of the robot arms can be pivotable along parallel, in particular horizontal, displacement planes.

In order to facilitate gripping of objects from a common mounting plane, e.g., from a plurality of containers standing on a building floor, it may also be advantageous if the second limbs of the robot arms are designed in such a way that the bearing points of the spindles on the second limbs are at the same height along the main axis.

Within the scope of an advantageous development, the end effectors can each be connected, in particular repeatably detachably, via a coupling device to the corresponding robot arm, in particular to the respective spindle. For example, it is conceivable that the end effectors are connected via a magnetic connection to the robot arm, in particular the spindle.

In particular, the coupling devices can each be designed in such a way that the respective end effector is pivotable about a pivot axis relative to the robot arm/spindle to which the end effector is coupled via the coupling device. The pivot axis is in particular oriented orthogonally to the main axis or the spindle axis, preferably horizontally. Such an embodiment makes it possible to adjust the end effector simply and reliably relative to the robot arm and to thus adapt an orientation of the end effector, for example as a function of a position and orientation of an object to be gripped.

In this context, it may also be advantageous if the handling system also comprises a drive device, in particular a drive device for each robot arm, designed to drive a pivoting movement of the end effector about the fourth axis. This makes it possible to automatically change an orientation of the end effector. Then, the control device described above can advantageously also be designed to control the drive device(s).

The invention is explained in more detail below with reference to the figures. In the drawings:

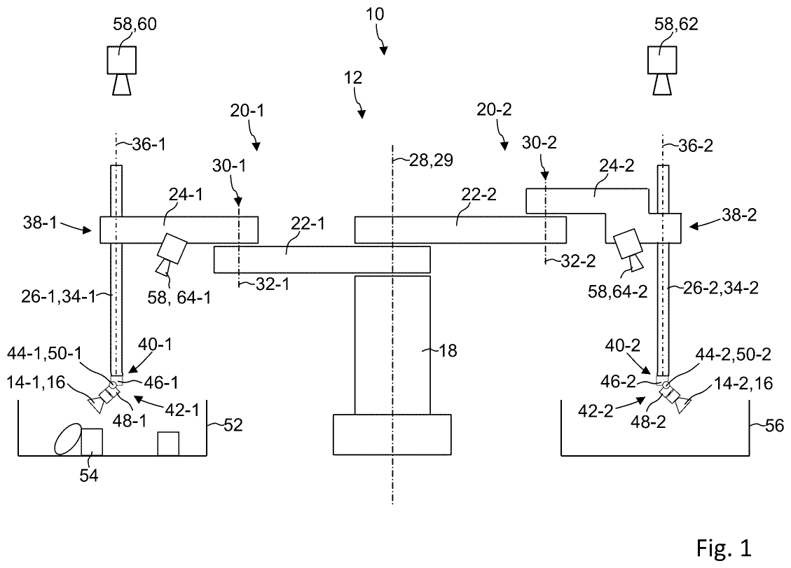

FIG. 1 shows a simplified schematic representation of an embodiment of the handling system in a side view;

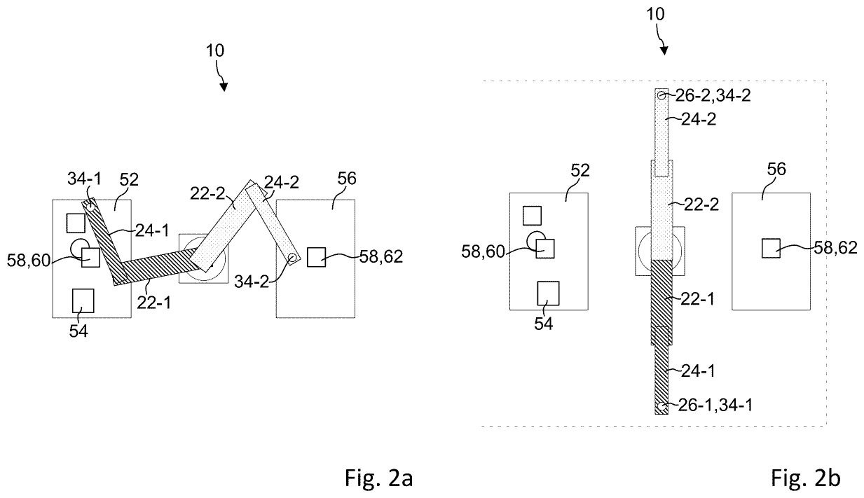

FIGS. 2a, b show simplified schematic representations of the handling system according to FIG. 1 in a plan view with different robot positions;

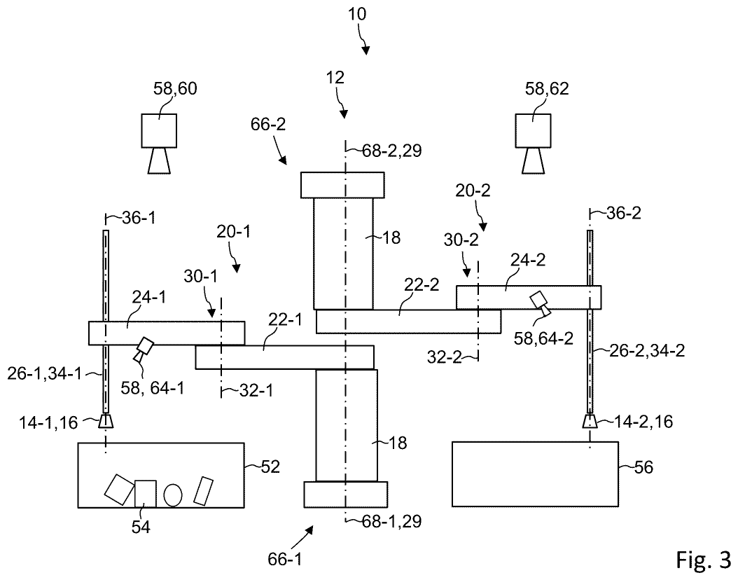

FIG. 3 shows a simplified schematic representation of a further embodiment of the handling system in a side view; and

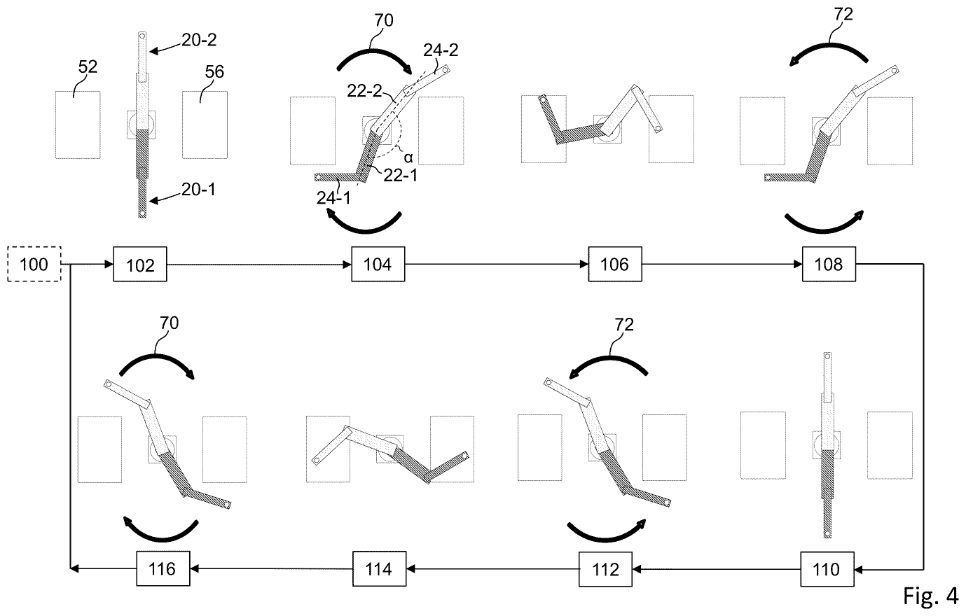

FIG. 4 shows simplified schematic representations of a handling system for explaining an exemplary method for handling objects by means of the handling system.

In the following description and in the figures, identical reference signs are in each case used for identical or corresponding features.

FIG. 1 shows, in a simplified schematic representation, an embodiment of a handling system, which is denoted as a whole by reference sign 10.

The handling system 10 comprises a robot 12 and a plurality of, in the example shown two, end effectors 14-1, 14-2, which are displaceable by the robot 12 (which is explained in more detail below).

In the example shown, the end effectors 14-1, 14-2 are designed as suction grippers 16 for sucking an object. However, in embodiments not shown, it is also conceivable for the end effectors 14-1, 14-2 or a subset thereof to be designed as mechanical grippers, e.g., as pneumatically actuated mechanical grippers.

In the example shown, the robot 12 comprises a robot base 18 and a plurality of, in the example shown, two robot arms 20-1, 20-2.

The robot arms 20-1, 20-2 each have Scara kinematics. In the specific example, each robot arm 20-1, 20-2 has three successively arranged limbs 22-1, 22-2, 24-1, 24-2, 26-1, 26-2, wherein a third limb 26-1, 26-2 is formed by a spindle 34-1, 34-2. However, other embodiments are also conceivable.

As can be seen from FIG. 1, the first limbs 22-1, 22-2 of the robot arms 20-1, 20-2 are connected to the robot base 18 so as to pivot, in particular rotate, about a first axis 28.

In this respect, the first axis 28 forms a main axis 29 of the robot 12. Preferably, the first limbs 22-1, 22-2 are mounted on the robot base 18 via a common bearing. The robot 12 in particular has corresponding drive apparatuses (not shown) for driving a pivoting movement of the first limbs 22-1, 22-2 of the robot arms 20-1, 20-2 about the main axis 29.

A respective second limb 24-1, 24-2 of a robot arm 20-1, 20-2 is connected via a pivot joint 30-1, 30-2 to the first limb 22-1, 22-2 of this robot arm 20-1, 20-2 and is pivotable about a respective second axis 32-1, 32-2 relative to the first limb 22-1, 22-2. The robot 12 preferably comprises corresponding drive apparatuses (not shown) for driving a respective pivoting movement of the second limbs 24-2, 24-2 about the respective second axis 32-1, 32-2.

A respective third limb 26-1, 26-2 of a robot arm 20-1, 20-2 is formed by a spindle 34-1, 34-2, which extends with its main longitudinal axis along a spindle axis 36-1, 36-2. The spindles 34-1, 34-2 are mounted on the second limb 24-1, 24-2 of the respective robot arm 20-1, 20-2 so as to rotate about the respective spindle axis 36-1, 36-2.

As mentioned above, the spindles 34-1, 34-2 can be designed in particular as ball roller spindles which can perform both a rotational movement about the spindle axis 36-1, 36-2 and a translational displacement movement along the spindle axis 36-1, 36-2. Corresponding drive devices and/or transmission devices for driving a movement of the spindles 34-1, 34-2 can then be provided in the respective second limb 24-1, 24-2 of the corresponding robot arm 20-1, 20-2.

The axes 28, 32-1, 32-2, 36-1, 36-2 of the robot 12 are, by way of example and preferably, oriented parallel to one another and run vertically in the example.

As can be seen from FIG. 1, the first limbs 22-1, 22-2 are, by way of example, arranged at an offset from one another along the first axis 28 so that the first limb 22-1 of the first robot arm 20-1 in the example can be pivoted through under the first limb 22-2 of the second robot arm 20-2. In order to compensate for this axial offset, the second limb 24-2 of the second robot arm 20-2 in the example shown is optionally offset or bent in such a way that corresponding bearing points 38-1, 38-2 of the spindles 34-1, 34-2 on the second limbs 24-1, 24-2 are at the same height along the first axis 28/main axis 29. In this respect, the bearing points 38-1, 38-2 of the spindles 34-1, 34-2 are arranged on a common plane which is oriented orthogonally to the first axis 28.

As shown in FIG. 1, end effectors 14-1, 14-2 are arranged on the bottom ends 40-1, 40-2 of spindles 34-1, 34-2 in the drawing. In the example, the end effectors 14-1, 14-2 are each connected via an optional coupling device 42-1, 42-2 to the corresponding spindle 34-1, 34-2.

By way of example, the optional coupling devices 42-1, 42-2 are each designed in such a way that the corresponding end effector 14-1, 14-2 is pivotable about a respective pivot axis 44-1, 44-2 relative to the spindle 34-1, 34-2. As can be seen from FIG. 1, the respective pivot axis 44-1, 44-2 is, by way of example and preferably, oriented orthogonally to the spindle axis 36-1, 36-2 (and thus also to the main axis 29 and the second axis 32-1, 32-2).

In the specific example, the coupling devices 42-1, 42-2 each comprise a connection portion 46-1, 46-2, which is connected, in particular in a rotationally fixed manner, to the spindle 34-1, 34-2, and a pivot portion 48-1, 48-2, which is mounted via a pivot joint 50-1, 50-2 on the connection portion 46-1, 46-2 so as to pivot about the pivot axis 44-1, 44-2. A coupling portion, via which the end effector 14-1, 14-2 can be coupled, can then be arranged on the pivot portion 48-1, 48-2. For example, it is conceivable that the coupling portion is designed as a quick-change clutch which enables repeated coupling and decoupling of an end effector 14-1, 14-2.

In order to pivot the respective pivot portion 48-1, 48-2, and thus an end effector 14-1, 14-2 coupled thereto, about pivot axis 44-1, 44-2, the handling system 10 may also comprise a drive device (not shown), in particular a drive device for each robot arm 20-1, 20-2. In this context, it is conceivable, for example, for the drive device to comprise an electromotive or pneumatic drive.

The handling system 10 also comprises a source container 52 for receiving objects 54 and a target container 56 for receiving objects 54. FIG. 1 shows the handling system 10 in an exemplary application situation at the beginning of a handling process, in which situation a plurality of objects 54 is arranged in the source container 52, whereas the target container 56 is still empty. The objects 54 can have different sizes and shapes and be arranged both in an ordered manner and in an unordered manner in the source container 52.

As can be seen from FIG. 1, the robot arms 20-1, 20-2 are arranged in such a way that they are pivotable in relation to the main axis 29 across the source container 52 and the target container 56.

By way of example and preferably, the source container 52 and the target container 56 are arranged opposite one another in relation to the main axis 29 (cf. FIGS. 2a and 2b). In principle, however, other arrangements of the source container 52 and the target container 56 are also possible.

The source container 52 and the target container 56 are arranged in such a way that by means of the end effectors 14-1, 14-2, the robot arms 20-1, 20-2 can grip objects 54 from the source container 52 and can transfer them into the target container 56 (which is explained below in detail with reference to the method).

FIG. 2a shows the handling system 10 in a configuration in which the first robot arm 20-1 has approached the source container 52 and the second robot arm 20-2 has approached the target container 56. As can be seen from FIG. 2a, this means that the first robot arm 20-1 is arranged above the source container 52 in a view from above along the main axis 29 (i.e., in a view onto the drawing plane) (so that the robot arm 20-1 can grip objects 54 from the source container 52 by means of the end effector 14-1) and that the second robot arm 20-2 is arranged above the target container 56 (so that the robot arm 20-2 can deposit objects 54 into the target container 56 by means of the end effector 14-2).

As shown in FIG. 2b, the source container 52 and the target container 56 are arranged in such a way that the robot arms 20-1, 20-2 can assume a zero position (shown in FIG. 2b) between the source container 52 and the target container 56, in which position the robot arms 20-1, 20-2 are arranged neither above the source container 52 nor above the target container 56 in a view along the main axis 29 (i.e., in a view orthogonal onto the drawing plane).

This makes it possible to detect the source container 52 and/or the target container 56 and, optionally, objects 54 arranged thereon, from above without a disruptive contour through the robot arms 20-1, 20-2 and to thus characterize, for example, the geometry and/or position and orientation of objects 54 received in the containers 52, 56.

For this purpose, the handling system 10 comprises an identification device 58 which is designed to characterize the source container 52 and the target container 56 and, optionally, objects 54 arranged thereon.

As shown in FIG. 1, the identification device 58 comprises a source container detection unit 60 for detecting the source container 52. The source container detection unit 60 is arranged above the source container 52 in relation to the main axis 29 in such a way that the robot arms 20-1, 20-2 can be pivoted through between the source container 52 and the source container detection unit 60. Analogously, the handling system 10 also comprises a target container detection unit 62 for detecting the target container 56. As indicated schematically in FIG. 1, the source container detection unit 60 and/or the target container detection unit 62 may each comprise a camera. As mentioned above, the source container detection unit 60 can in particular be designed to identify the nature, geometry and/or position and orientation of one or more of the objects 54 arranged in the source container 52. The target container detection unit 62 can be designed to identify a deposit position in the target container 56 for an object held by the robot 2. The target container detection unit 62 can also be designed to identify the nature, geometry and/or position and orientation of one or more objects 54 arranged in the target container 56.

The identification device 58 can comprise further units, e.g., a data processing unit for analyzing image data. In the example shown, the identification device 58 also comprises optional further detection units 64-1, 64-2, wherein one of these further detection units 64-1, 64-2 is arranged on each robot arm 20-1, 20-2 (cf. FIG. 1). The further detection units 64-1, 64-2 are in particular designed to monitor objects 54 held on the end effectors 14-1, 14-2.

The handling system 10 also comprises a control device (not shown) for controlling the robot 12 and, optionally, for controlling an optionally provided drive device for driving a pivoting movement of the end effectors 14-1, 14-2 about pivot axes 44-1, 44-2.

FIG. 3 shows a further embodiment of the handling system 10, in which the robot arms 20-1, 20-2 are not mounted on a common robot base 18 but are each part of an independent robot unit 66-1, 66-2. In this respect, the handling system 10 according to FIG. 2 comprises a first robot unit 66-1, which provides the first robot arm 20-1 and is designed as a Scara robot unit in the example, and a second robot unit 66-2, which provides the second robot arm 20-2 and is likewise designed as a Scara robot unit in the example.

By way of example, the first robot unit 66-1 can be provided by a first Scara robot which is arranged on a building floor, and the second robot unit 66-2 can be provided by a second Scara robot which is arranged on a carrier, e.g., on a ceiling of a building.

As shown schematically in FIG. 3, the robot units 66-1, 66-2 each have a robot base 18 on which the respective first limb 22-1, 22-2 of the corresponding robot arm 20-1, 20-2 is mounted so as to pivot about a respective first axis 68-1, 68-2. The robot units 68-1, 68-2 are preferably arranged in such a way that the first axes 68-1, 68-2 run at least substantially coaxially so that the two robot arms 20-1, 20-2 of the robot units 66-1, 66-2 are ultimately pivotable about a common main axis 29.

Otherwise, the structure of the handling system 10 according to FIG. 3 substantially corresponds to the embodiment according to FIG. 1 so that reference is made to the above statements in this respect in order to avoid repetition. Identical reference signs denote functionally identical or similar components.

In deviation from the from the example shown in FIG. 1, the end effectors 14-1, 14-2 in the embodiment according to FIG. 3 are connected, by way of example, to the spindles 34-1, 34-2 without a pivot coupling. However, it is also conceivable for the coupling devices 42-1, 42-2 shown in FIG. 1 to also be provided in the handling system 10 according to FIG. 3.

An advantageous embodiment of a method for handling objects 54 by means of the handling system 10 is explained below with reference to FIG. 4.

In an initial step 100, the robot arms are transferred into the zero position (step a).

In a further step 102 (step b), the source container 52 and/or the target container 56 are characterized in this robot position by means of the identification device 58. In particular, the source container 52 is detected visually by means of the source container detection unit 60 and/or the target container 56 is detected visually by means of the target container detection unit 62. As mentioned above, it is in particular conceivable that in step 102, object information on one or more of the objects 54 received in the source container 52 is ascertained and/or possible deposit positions in the target container 56 are ascertained.

In a further step 104 (step c), the robot arms 20-1, 20-2 are then pivoted about the main axis 29 in a first direction 70 (cf. arrows denoted by reference sign 70, in the clockwise direction in the example) so that the first robot arm 20-1 approaches the source container 52 and the second robot arm 20-2 approaches the target container 56 (or vice versa). In this respect, the robot arms 20-1, 20-2 each approach a different container 52, 56.

A movement of the robot arms 20-1, 20-2 about the main axis 29 is preferably synchronized in such a way that an angle α enclosed by the first limbs 20-1, 20-2 around the main axis 29 is not less than 120°, in particular not less than 140°.

In a further step 106 (step d), an object 54 is gripped from the source container 52 by means of the end effector 14-1 of the first robot arm 20-1 (i.e., the robot arm 20-1 that has approached the source container 52). For this purpose, it is conceivable that the end effector 14-1 of the first robot arm 20-2 is moved by means of the spindle 34-1 along the spindle axis 36-1 in the direction of the source container 52. Optionally, the end effector 14-1 is pivoted about the pivot axis 44-1 before the object 54 is gripped, for example in order to adapt the orientation of the end effector 14-1 to a position and orientation of the object 54 to be gripped. In the event that an object 54 is held on the end effector 14-2 of the second robot arm 20-2, this object 54 is deposited in step 106 at a deposit position in the target container 56. For this purpose, it is conceivable that the end effector 14-2 of the second robot arm 20-2 is moved by means of the spindle 34-2 along the spindle axis 36-2 in the direction of the target container. Optionally, the end effector 14-2 is pivoted about the pivot axis 44-2 before the object 54 is deposited, for example in order to adapt the orientation of the end effector 14-2 to a deposit position in the target container 56.

As explained above, preferably, the first robot arm 20-1 approaches the source container 52 (step 104), an object 54 is gripped from the source container 52 and/or the end effector 14-1 is optionally pivoted (step 106) as a function of object information previously optionally ascertained in step 102. Likewise preferably, the second robot arm 20-2 approaches the target container 56 (step 104), the end effector 14-2 is pivoted and/or the object 54 is deposited into the target container (step 106) as a function of a deposit position, previously ascertained in step 102, in the target container 56.

In a further step 108 (step e), the robot arms 20-1, 20-2 are pivoted in a second direction 72 opposite to the first direction 70 (in the counterclockwise direction in the example) about the main axis 29 until the robot arms 20-1, 20-2 again assume the zero position. However, in embodiments (not shown), it is also possible for the robot arms 20-1, 20-2 to be pivoted further in the first direction 70 so that no change in direction is required.

In a further step 110 (step f), the source container 52 and/or the target container 56 is then characterized, analogously to step 102, by means of the identification device 58.

In a further step 112 (step g), the robot arms 20-1, 20-2 are then pivoted further in the second direction 72 such that the first robot arm 20-1 approaches the target container 56 and the second robot arm 20-2 approaches the source container 52.

In a further step 114 (step h), analogously to step 106, an object 54 is now gripped from the source container 52 by means of the end effector 14-2 of the second robot arm 20-2 (i.e., the robot arm 20-2 that has approached the source container 52). Optionally, the end effector 14-2 is pivoted about the pivot axis 44-2 before the object 54 is gripped, for example in order to adapt the orientation of the end effector 14-2 to a position and orientation of the object 54 to be gripped. Moreover, the object 54 gripped in step 106 by the end effector 14-1 of the first robot arm 20-1 is now deposited into the target container 56, in particular at a deposit position, ascertained in step 110, in the target container 56. Optionally, the end effector 14-1 is pivoted about the pivot axis 44-1 before the object 54 is deposited, for example in order to adapt the orientation of the end effector 14-2 to a deposit position in the target container 56.

Preferably, the robot arms are pivoted in step 112, the end effector 14-2 is optionally pivoted and/or the object 54 is gripped from the source container 52 (step 114) as a function of step 110, in particular as a function of object information optionally ascertained step 110. Preferably, the first robot arm 20-1 approaches the target container 56 (step 112), the end effector 14-1 is optionally pivoted and/or the object 54 is deposited into the target container (step 114) as a function of a deposit position, previously optionally ascertained in step 110, in the target container 56.

In a further step 116, the robot arms 20-1, 20-2 are now again transferred into the zero position in the first direction 70 about the main axis 29. Preferably, the method is then repeated from step 102, in particular until all objects 54 or a previously defined subset of the objects 54 are transferred from the source container 52 into the target container 56.

1. A method for handling objects (54) by means of a handling system (10), having:
a robot (12) having robot arms, including a first robot arm (20-1) and a second robot arm (20-2), each robot arm having a respective end effector (14-1, 14-2) arranged for gripping an object (54) in each case, wherein the robot arms (20-1, 20-2) are pivotable about a common main axis (29), wherein the robot arms (20-1, 20-2) each have Scara kinematics;
a source container (52) for receiving objects (54) and a target container (56) for receiving the objects (54), wherein the source container (52) and the target container (56) are arranged distributed around the common main axis (29) in such a way that the robot arms (20-1, 20-2) can transfer the objects (54) from the source container (52) into the target container (56), that the robot arms (20-1, 20-2) are pivotable across the source container (52) and the target container (56), and that the robot arms (20-1, 20-2) can assume a zero position in which the robot arms (20-1, 20-2) are located neither above the source container (52) nor above the target container (56);
an identification device (58) having
a source container detection unit (60), including a first camera, which is designed to detect the source container (52), including visually, and
a target container detection unit (62), including a second camera, which is designed to detect visually the target container (56),
wherein the robot arms (20-1, 20-2) are pivoted about the common main axis (29) in such a way that each robot arm (20-1, 20-2) alternately approaches the source container (52) and the target container (56), wherein a movement of the robot arms (20-1, 20-2) is synchronized in such a way that when the first robot arm (20-1) approaches the source container (52), the second robot arm (20-2) approaches the target container (56), and vice versa, wherein the robot arms (20-1, 20-2) pass through the zero position during their movement between the source container (52) and the target container (56), wherein, when the robot arms (20-1, 20-2) are in the zero position, the source container (52) and/or the target container (56) is characterized, including visually detected, by means of the identification device (58).

2. A method according to claim 1, comprising the following steps:
a) transferring the robot arms into the zero position, including by pivoting the robot arms (20-1, 20-2) about the common main axis (29);
b) characterizing the source container (52) and/or the target container (56) by means of the identification device (58), including capturing at least one image of the source container (52) and/or capturing at least one image of the target container (56) by means of the identification device (58);
c) pivoting the robot arms (20-1, 20-2) in a first direction (70) about the common main axis (29) in such a way that the first robot arm (20-1) approaches the source container (52) and the second robot arm (20-2) approaches the target container (56);
d) gripping the object (54) from the source container (52) by means of the respective end effector (14-1) of the first robot arm (20-2), and, in the case that the object (54) is held on the respective end effector (14-2) of the second robot arm (20-2), depositing this object (54) into the target container (56);
e) transferring the robot arms (20-1, 20-2) into the zero position, including by pivoting the robot arms (20-1, 20-2) in a second direction (72), opposite to the first direction (70), about the common main axis (29);
f) characterizing the source container (52) and/or the target container (56) by means of the identification device (58), including capturing at least one image of the source container (52) and/or at least one image of the target container (56) by means of the identification device (58);
g) pivoting the robot arms (20-1, 20-2) in the first direction (70), or in the second direction (72) opposite to the first direction (70), about the common main axis (29) in such a way that the first robot arm (20-1) approaches the target container (56) and the second robot arm (20-2) approaches the source container (52);
h) gripping the object (54) from the source container (52) by means of the respective end effector (14-2) of the second robot arm (20-2), and, in the case that the object (54) is held on the end effector (14-1) of the first robot arm (20-1), depositing this object (54) into the target container (56).

3. A method according to claim 1, wherein the robot arms (20-1, 20-2) approach the source container (52) or the target container (56), the object (54) is gripped from the source container (52) and/or the object (54) is deposited into the target container (56) as a function of a result of the characterization of the source container (52) or of the target container (54) by means of the identification device (58).

4. A method according to claim 1, wherein the identification device (58), including the source container detection unit (60), is designed to ascertain object information on one or more objects (54) arranged in the source container (52), including the geometry and/or position and orientation thereof,
wherein characterizing the source container (52) comprises ascertaining object information on one or more objects (54) arranged in the source container (52).

5. A method according to claim 2, wherein the robot arms (20-1, 20-2) approach the source container in steps c) and g) and/or the object (54) is gripped in steps d) and h) as a function of object information ascertained by the identification device (58).

6. A method according to claim 4, wherein ascertaining the object information comprises one or more of the following steps:
ascertaining a geometry, including an outer shape, and/or position and orientation of one or more of the objects (54) arranged in the source container (52);
ascertaining a gripping point on one or more of the objects (54) arranged in the source container (52).

7. A method according to claim 1, wherein the identification device (58), including the target container detection unit (62), is designed to ascertain a deposit position in the target container (56), wherein the characterization of the target container (56) comprises ascertaining one or more deposit positions in the target container (56), including for the objeCt (54) gripped by the robot (12).

8. A method according to claim 2, wherein the robot arms (20-1, 20-2) approach the target container (56) in steps c) and g) and/or the object (54) is deposited in steps d) and h) as a function of a deposit position, ascertained by the identification device (58), in the target container (56).

9. A method according to claim 7, wherein ascertaining the deposit position comprises selecting a deposit position from the plurality of identified deposit positions, including as a function of one or more of the following boundary conditions:
nature and/or geometry, including size and/or outer shape, of an object (54) held by the robot (12) at this time;
nature, geometry and/or position and orientation of the objects (54) already arranged in the target container (56) at this time.

10. A method according to claim 1, wherein respective end effectors (14-1, 14-2) are each connected via a coupling device (42-1, 42-2) to a corresponding robot arm (20-1, 20-2) in such a way that the respective end effector (14-1, 14-2) is pivotable about a respective pivot axis (44-1, 44-2) relative to the robot arm (20-1, 20-2),
wherein before an object (14) is gripped from the source container (52) and/or before an object (54) is deposited into the target container (56), the corresponding end effector (14-1, 14-2) is pivoted about the respective pivot axis (44-1, 44-2), including as a function of object information, or a deposit position, previously ascertained by the identification device (58).

11. A method according to claim 1, wherein the robot arms (20-1, 20-2) each have three successively arranged limbs (22-1, 22-2, 24-1, 24-2, 26-1, 26-2), wherein a respective first limb (22-1, 22-2) is pivotable about the common main axis (29), wherein a pivoting movement of first limbs (22-1, 22-2) about the common main axis (29) is synchronized in such a way that an angle (a) enclosed between the respective first limb (22-1) of the first robot arm (20-1) and a corresponding first limb (22-2) of the second robot arm (20-2) around the common main axis (29) is not less than 120°, including either not less than 140°, or not less than 160°, or not less than 170°, or not less than 175°.

12. A method according to claim 1, wherein the identification device (58) comprises further detection units (64-1, 64-2), including further cameras, wherein one of the further detection units (64-1, 64-2) is arranged on each robot arm (20-1, 20-2), wherein, when the object (54) is held on an end effector (14-1, 14-2) of a robot arm (20-1, 20-2), this object (54), including its position and orientation on the end effector (14-1, 14-2), is monitored by means of a further detection unit (64-1, 64-2) arranged on this robot arm (20-1, 20-2).

13. A handling system (10), comprising:
a control device for controlling the handling system (10) configured to carry out the method according to claim 1.

14. A handling system according to claim 13, wherein the robot (12) comprises a first Scara robot unit (66-1) providing the first robot arm (20-1), and a second Scara robot unit (66-2) providing the second robot arm (20-2).

15. A handling system according to claim 13, wherein the robot (12) has a robot base (18), wherein the first robot arm (20-1) and the second robot arm (20-2) are fastened to the robot base (18) so as to pivot about the common main axis (29).

16. A handling system according to claim 13, wherein the robot arms (20-1, 20-2) each have a spindle (34-1, 34-2), wherein the end effector (14-1, 14-2) of a respective robot arm (20-1, 20-2) is arranged on the spindle (34-1, 34-2) of this robot arm (20-1, 20-2), including wherein the respective spindle (34-1, 34-2) are designed to drive a translational and/or a rotational actuating movement with respect to a respective spindle axis (36-1, 36-2) parallel to the common main axis (29).

17. A handling system according to claim 13, wherein the robot arms (20-1, 20-2) each have three successively arranged limbs (22-1, 22-2, 24-1, 24-2, 26-1, 26-2), wherein a respective first limb (22-1, 22-2) is pivotable about a first axis (28) corresponding to the common main axis (29), including mounted on a robot base (18), wherein a respective second limb (24-1, 24-2) is connected to the first limb (22-1, 22-2) so as to pivot about a respective second axis (32-1, 32-2), wherein a respective third limb (26-1, 26-2) is formed by the respective spindle (34-1, 34-2), wherein the spindle (34-1, 34-2) is connected to the second limb (24-1, 24-2) so as to rotate about the spindle axis (36-1, 36-2).

18. A handling system according to claim 13, wherein axes (29, 32-1, 32-2, 36-1, 36-2) of the robot arms (20-1, 20-2) run parallel to one another, including vertically.

19. A handling system according to claim 13, wherein the end effectors (14-1, 14-2) are each connected via a coupling device (42-1, 42-2) to the corresponding robot arm (20-1, 20-2), including the respective spindle (34-1, 34-2), in such a way that the respective end effector (14-1, 14-2) is pivotable about a respective pivot axis (44-1, 44-2) relative to the robot arm (20-1, 20-2), including the spindle (34-1, 34-2).
